(19) United States
(12) Patent Application Publication
(10) Pub. No.: US 2026/0238914 A1
(43) Pub. Date: Aug. 13, 2026

(54) Open-Ear Headphone with Fit-Enhancing Cover

(71) Applicant: Bose Corporation, Framingham, MA (US)

(72) Inventors: Brian David Beaudoin, Franklin, MA (US); Nathan Thomas Smith, Worcester, MA (US); Vanvisa Attaset, Sudbury, MA (US); Andrew LaFosse, Gardner, MA (US)

(21) Appl. No.: 19/049,096

(22) Filed: Feb. 10, 2025

(51) Int. Cl. H04R 1/10

(52) U.S. Cl. CPC H04R 1/105; H04R 1/1008; H04R 1/1075

(57) ABSTRACT

Aspects include open-ear headphones. In certain cases, an open-ear headphone includes: an acoustic module configured to be located at least in part in a cavum conchae of an outer ear of a user, the acoustic module having an acoustic transducer and a first sound-emitting opening; a body coupled to the acoustic module, the body having: a first portion configured to pass over an outer side of at least one of an anti-helix, a helix, or a lobule of the outer ear, and a second portion configured to be located behind the outer ear; and a cover over the body for controlling a fit of the open-ear headphone on the ear.

### BACKGROUND

The disclosure relates generally to wearable audio devices. More particularly, the disclosure relates to headphones such as open-ear headphones.

### SUMMARY

Various implementations are directed to headphones. In certain cases, a headphone includes an ear cuff and an acoustic package configured to deliver sound to the ear canal region. The headphone can include a cover for controlling fit.

In particular cases, an open-ear headphone includes: an acoustic module configured to be located at least in part in a cavum conchae of an outer ear of a user, the acoustic module having an acoustic transducer and a first sound-emitting opening; a body coupled to the acoustic module, the body having: a first portion configured to pass over an outer side of at least one of an anti-helix, a helix, or a lobule of the outer ear, and a second portion configured to be located behind the outer ear; and a cover over the body for controlling a fit of the open-ear headphone on the ear

All examples and features mentioned below can be combined in any technically possible way.

In certain cases, the cover is removable.

In certain cases, the body is sized to receive a plurality of distinct covers for providing distinct fits of the open-ear headphone on the ear of the user.

In certain cases, distinct covers provide distinct clamping forces on the ear of the user. In some examples, the distinct clamping forces are provided based on distinct durometers, distinct thicknesses, and/or surface features.

In certain cases, the cover is configured for placement in a plurality of positions to adjust a clamping force on the ear of the user.

In certain cases, the cover is rotatable relative to the second portion to achieve the plurality of positions.

In certain cases, the cover includes a gap aligned with an axis of the first portion of the body, the gap enabling rotation of the cover relative to the second portion of the body.

In certain cases, the cover has a non-uniform thickness such that interaction between a first portion of the cover and the user's ear provides a distinct fit from interaction between a second portion of the cover and the user's ear.

In certain cases, the non-uniform thickness provides a progressive or regressive fit adjustment between at least three positions.

In certain cases, the cover includes at least one surface feature for enhancing grip on the ear of the user. In some examples, the surface feature(s) include dimples, bumps, ribs, etc.

In some cases, the cover includes a surface treatment that provides differentiated surface friction. The differentiated surface friction can provide grip and/or enhance comfort. In some cases, surface treatments are provided by soft touch coatings, plasma treatments and/or textures.

In certain cases, the cover includes at least one compliant surface feature for enhancing fit on the ear of the user. Example compliant surface features can include compliant projections or protrusions, or castellations.

In certain cases, adjusting the cover provides a majority of an adjustment in clamping force of the open-ear headphone.

In certain cases, the cover has a directional distinction in grip force characterized by a greater grip force in a direction along a primary axis of the second portion than in a direction perpendicular to the primary axis of the second portion.

In certain cases, the directional distinction in grip force enables rotation of the cover relative to the second portion.

In certain cases, the cover includes a reinforcing ring aligned in a plane perpendicular to the primary axis of the second portion.

In certain cases, the cover includes a plurality of internal detents for enabling fit adjustment relative to the user's ear.

In certain cases, the cover includes at least one of silicone, thermoplastic elastomer (TPE), foam, A9, or PCM (phase change material).

In certain cases, the second portion includes a battery housing that houses a battery.

In certain cases, an outer surface of the battery housing includes a non-compliant material.

In certain cases, the first sound-emitting opening is configured to be spaced from and proximate the user's ear canal opening.

In certain cases, at least one of the anti-helix, the helix, or the lobule of the outer ear is configured to be located between the first portion and the second portion of the body.

In certain cases, the body is generally L-shaped.

In certain cases, the acoustic module and the body together are generally C-shaped.

In certain cases, the headphone further includes at least one microphone located in the acoustic module and/or the body.

Two or more features described in this disclosure, including those described in this summary section, may be combined to form implementations not specifically described herein.

The details of one or more implementations are set forth in the accompanying drawings and the description below. Other features, objects and benefits will be apparent from the description and drawings, and from the claims.

### BRIEF DESCRIPTION OF THE DRAWINGS

Various aspects of at least one example are discussed below with reference to the accompanying figures, which are not intended to be drawn to scale. The figures are included to provide illustration and a further understanding of the various aspects and examples and are incorporated in and constitute a part of this specification, but are not intended as a definition of the limits of the inventions. In the figures, identical or nearly identical components illustrated in various figures may be represented by a like reference character or numeral. For purposes of clarity, not every component may be labeled in every figure. In the figures:

FIG. 1 is a perspective view of an example headphone with a cover removed according to various implementations.

FIG. 2 is a perspective view of the headphone of FIG. 1 with a cover according to various implementations.

FIG. 3 is a schematic depiction of a headphone on a user's ear according to various implementations.

FIG. 4 is a perspective view of an example headphone cover over a portion of a headphone according to various implementations.

FIG. 5 is a perspective view of an additional example headphone cover over a portion of a headphone according to various implementations.

FIGS. 6-8 illustrate distinct surface features and/or detents in a surface of a cover according to various implementations.

FIG. 9 illustrates a wall of a cover for a portion of a headphone according to various implementations.

It is noted that the drawings of the various implementations are not necessarily to scale. The drawings are intended to depict only typical aspects of the disclosure, and therefore should not be considered as limiting the scope of the implementations. In the drawings, like numbering represents like elements between the drawings.

### DETAILED DESCRIPTION

Various disclosed implementations include an open-ear headphone having an acoustic module and an ear cuff. The ear cuff has a first portion that passes over the outer side of the antihelix, helix and/or lobule of a user's ear, and a second portion that sits behind the outer ear. The acoustic module is configured to be located at least in part in a cavum conchae of an outer ear of a user. In various implementations, the headphone includes a cover over the one or more portions of the body for controlling a fit of the headphone on the ear. In particular examples, the cover is removable. In some additional examples, the body (e.g., first portion and/or second portion) is sized to receive a plurality of distinct covers for providing distinct fits on the ear of the user. In still further examples, the cover is configured for placement in a plurality of positions to adjust a clamping force on the ear of the user.

Relative to conventional headphones the disclosed open-ear headphone having an ear cuff and a cover enables enhanced comfort, retention, and/or acoustic performance. In some examples, the use of a cover with an ear cuff allows for a more secure fit across multiple use scenarios.

Commonly labeled components in the FIGURES are considered to be substantially equivalent components for the purposes of illustration, and redundant discussion of those components is omitted for clarity.

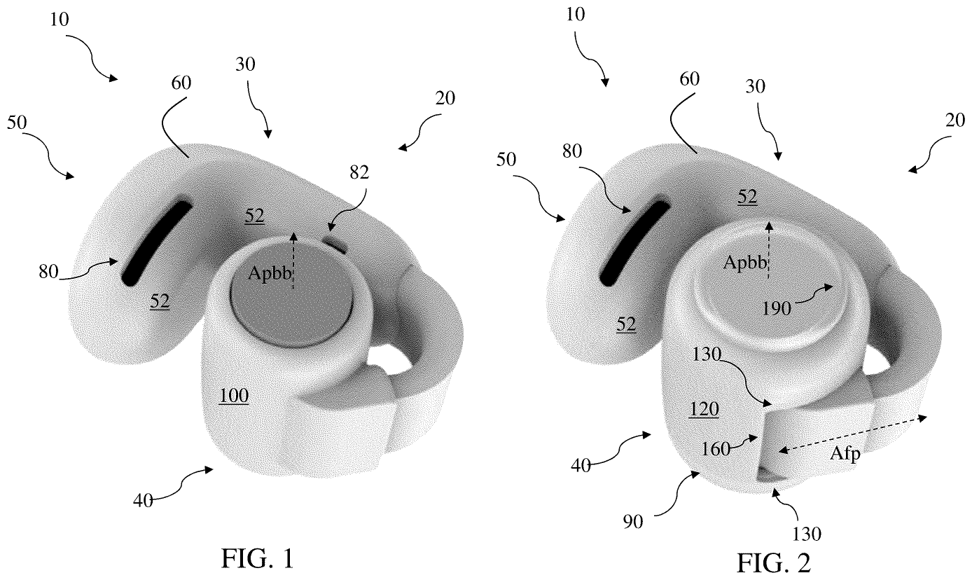

FIGS. 1 and 2 show perspective views of a headphone 10 according to various implementations. As described further herein, FIG. 1 shows the headphone 10 without a cover (also called a sleeve), while FIG. 2 shows the headphone 10 with the cover in a first position.

As noted herein, the headphone 10 includes an on-ear headphone that is configured to fit on a portion of a user's ear during wear. In certain cases, the headphone 10 includes at least one transducer (e.g., an electro-acoustic transducer) for providing an audio output, and in additional cases, at least one microphone. The headphone 10 can house various additional electronics as described herein. Further, electronics can be stored in various portions (or sections) of the headphone 10 depending on device configuration, usage, etc. In any case, the headphone 10 can be configured to mount on the user's ear and deliver an acoustic output to the region proximate the user's ear canal (e.g., ear canal entrance). Further, as noted herein, the headphone 10 is an open-ear headphone, that is, a headphone that does not obstruct the ear canal entrance of the user's ear.

In particular cases, the headphone 10 includes a body 20 that includes a first portion 30 configured to pass over an outer side of at least one of an anti-helix, a helix, or a lobule of the outer ear. The body 20 further includes a second portion 40 configured to be located behind the outer ear. A schematic depiction of the headphone 10 on a user's ear is illustrate in FIG. 2, which shows the outer side 200 of at least one of the antihelix 210, the helix 220, or the lobule 230 of the user's outer ear 240. In certain cases, the second portion 40 includes a battery housing that houses a battery. An acoustic module 50 is coupled to the body 20 and configured to be located at least in part in a cavum conchae of an outer ear 240 of the user. In an example, the body 20 is generally “L” shaped and the acoustic module 50 and body 20 together (i.e., the first portion 30, second portion 40, and acoustic module 50) are generally “C” shaped. In certain cases, at least one of the anti-helix 210, the helix 220, or the lobule 230 of the outer ear 240 is configured to be located between the first portion 30 and the second portion 40 of the body 20.

In some implementations, the ear cuff body 20 houses additional circuitry, such as conventionally found in a behind-the-ear (BTE) portion of a RIC hearing assistance device as incorporated by reference herein. For example, the body 20 can house a processor, a battery, one or more microphones, a communications module (e.g., a radio such as a BT radio), and memory (including instructions for controlling operations), sensors, audio components, communications components, power storage components, etc., not specifically denoted herein. In some cases, audio components include feedforward and/or feedback microphones, which can enable function such as active noise reduction (ANR) and/or active noise cancelation (ANC) by the headphone 10. As noted herein, one or more of the components or circuitry described as located in one portion of the audio device 10 can be located in another portion according to certain implementations.

In certain examples, to add compliance to body 20 and/or the acoustic module 50 such that it sits on the uneven surface of concavity, there may be a cushion or other compliant or compressible member 52 (FIG. 1) on all or part of body 20 and/or acoustic module 50, or these components can be made from a compliant material such as a foam. If light clamping of the headphone 10 to the ear is desirable, compliance can be built in. For example, at least first portion 30 or second portion 40 could be made of an elastomer or include a hinge element so that it can flex, thus altering the thickness of the gap between portions 30 and 40 that encompass ear portion. A suitable compliant elastomer may have a hardness of approximately 20-8050 durometer shore A, in one non-limiting example.

Generally, the outer ear (also known as the auricle or pinna) of a human includes a concha that is immediately adjacent to the entrance to the ear canal, which is underneath (or, behind) the tragus. The concha is divided by the helix crus into a lower portion termed the cavum conchae and an upper portion termed the cymba conchae. The cavum conchae is a generally bowl-shaped feature that is directly adjacent to the ear canal. The cavum conchae typically includes a depression bordered by the anti-tragus, which is the lower part of the anti-helix and/or bordered by the lobule. The lobule (i.e., the earlobe), which is at the lower end of the helix, is typically just below the anti-tragus. Additional description of ear anatomy is included, for example, in U.S. Pat. No. 11,140,469 (Open-Ear Headphone, issued Oct. 5, 2021), the entire contents of which are incorporated by reference.

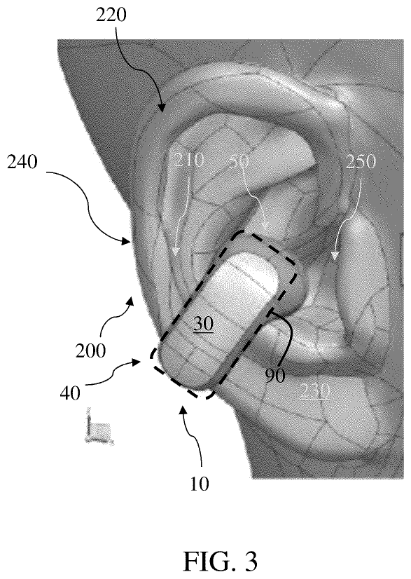

In various implementations, the acoustic module 50 can include a transducer (e.g., internal to housing 60, not shown) and one or more sound-emitting openings 80 for providing an audio output to the user's ear (e.g., a low frequency dipole). Openings 80 are configured to be spaced from and proximate the user's ear canal opening 250 (FIG. 3). As similarly described with respect to headphones in U.S. Pat. No. 11,140,469 (previously incorporated by reference herein), the acoustic module 50 can further include additional opening(s) 82 (FIG. 1), e.g., at another location, for providing a microphone input. Further openings for providing audio output may be provided on additional or alternative portions of the housing 60 (not shown).

As shown in FIGS. 2 and 3, the headphone 10 can further include a cover 90 configured to fit over one or more portions of the body 20 for controlling fit of the headphone 10 on the ear. In one example, as shown in FIG. 2, a cover 90 is configured to fit over the second portion 40 of the body 20 for controlling a fit of the headphone 10 on the ear. In further examples, shown in phantom in FIG. 3, a cover 90 is configured to fit over the first portion 30 and/or the second portion 40 of the body 20 for controlling a fit of the headphone 10 on the ear. It is understood that any cover 90 shown and described herein can be adapted to fit over one or more portions of the headphone body 20, e.g., over one or more parts of the first 30 and/or second portion 40. In certain cases where the cover 90 fits over the first portion 30, cover 90 can include cutouts or other apertures for mating with acoustic openings in the body 20 (e.g., openings 80, 82, etc.) to enable acoustic pass-through without interference.

Cover 90 can be removable, e.g., for replacement, cleaning, modularity, etc. In certain cases, the cover 90 is formed of a compliant material. According to certain implementations, the cover 90 includes silicone, thermoplastic elastomer (TPE), foam, A9, or PCM (phase change material). The cover 90 can be removable without a tool, e.g., with a user's fingernail or significant pressure between a user's fingers. In certain example cases illustrated in FIGS. 2, 4, and 5, the cover 90 is sized to fit over and cover a majority of the second portion 40 of the body 20. As noted herein, the second portion 40 can include a battery housing, otherwise referred to as a battery barrel.

In some examples, the outer surface 100 of the second portion 40 (FIG. 1) includes a non-compliant material, e.g., a hard plastic or a metal. In a particular implementation, the outer surface 100 includes acrylonitrile butadiene styrene (ABS) plastic or polycarbonate. In contrast to some conventional open-ear headphones, the outer surface 100 of one or more portions of the body 20 (e.g., second portion 40) can be formed of a non-compliant material thereby reducing manufacturing complexity, e.g., by removing a process such as providing a second (or additional) silicone shot. As described herein, the cover 90 can provide a compliant interface with the user's ear, in particular, the back of the outer ear. This cover 90 can beneficially enhance comfort and/or fit of the headphone 10 on the user.

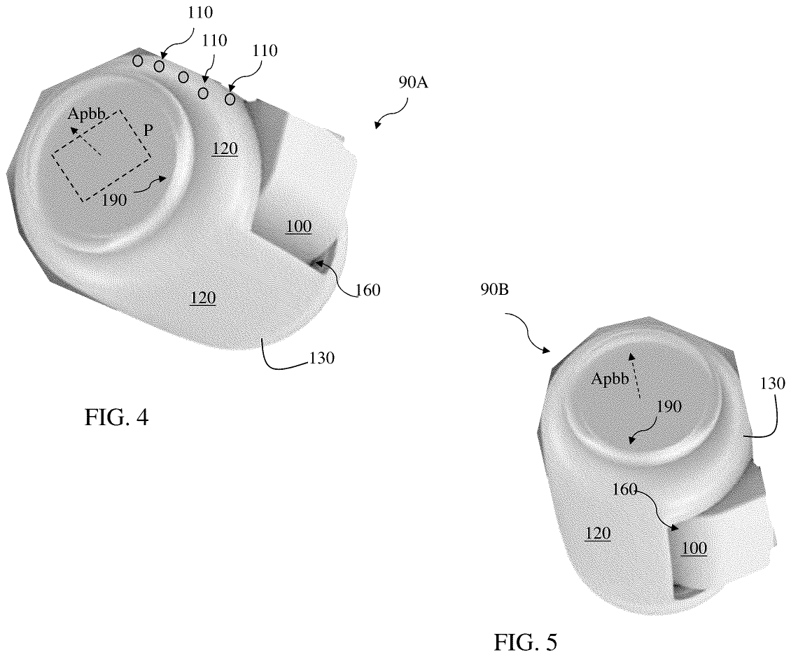

In particular implementations, the first portion 30 and/or second portion 40 is sized to receive a plurality of distinct covers 90 for providing distinct fits of the open-ear headphone 10 on the ear of the user. For example, FIG. 2 shows a first cover 90, while FIGS. 4 and 5 show distinct covers 90A, 90B, respectively, that are compatible with the second portion 40. It is understood that reference to cover 90 can include reference to any of the covers 90, 90A, 90B shown and described herein.

In some cases, covers 90, 90A, 90B, etc., can provide distinct fits of the headphone 10 on the ear of the user. In some examples, covers 90 can be custom fit or otherwise made-to-order based on specifications of a user's ear (e.g., imaging of a user's ear and/or other ear measurements). In one example, a three-dimensional (3D) scan of a user's ear can provide inputs for a custom cover 90.

In some examples, distinct covers 90, 90A, 90B, etc., can provide distinct clamping forces on the ear of the user. In particular cases, the distinct clamping forces are provided based on distinct durometers, distinct thicknesses, and/or surface features on the covers 90. In a particular example, the material of cover 90A has a distinct durometer and/or thickness relative to cover 90B. In one non-limiting example, cover 90A includes surface features 110 along a surface 120, e.g., a surface that is configured to contact the user's ear. The surface features 110 are illustrated as including dimples or bumps in FIG. 4. However, surface features 110 can also include ribs or other shapes (e.g., spring, leaf, or hallow cavities of compliance). In some examples, surface features 110 enhance grip and/or comfort on the ear of the user. In some cases, the cover includes a surface treatment that provides differentiated surface friction. The differentiated surface friction can provide grip and/or enhance comfort. In some cases, surface treatments are provided by soft touch coatings, plasma treatments and/or textures.

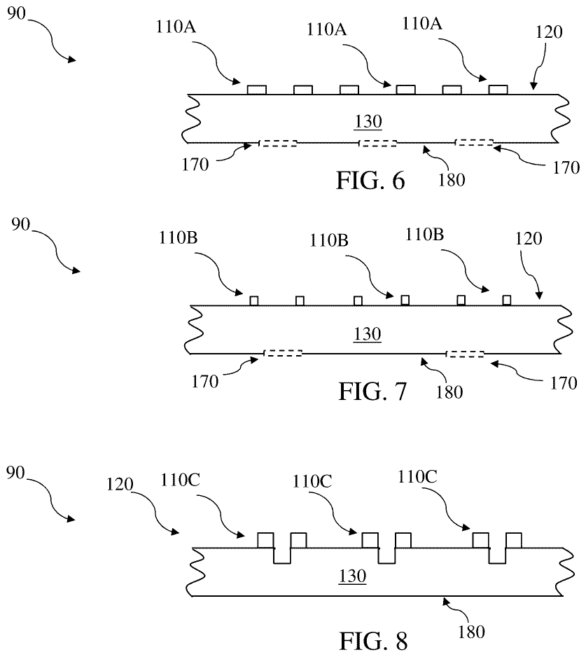

FIGS. 6-8 illustrate additional surface features 110A, 110B, 110C, etc., that can be located on surface 120 according to various additional implementations. In certain cases, these surface features 110 can include compliant surface features for enhancing fit on the ear of the user. Compliant surface features 110 can be configured to bend or flex to envelope the user's ear and/or distribute clamping pressure on the user's ear. Non-limiting examples of compliant surface features in FIGS. 6-8 can include projections 110A (FIG. 6), protrusions 110B (FIG. 7), or castellations 110C (FIG. 8). It is understood that any combination of surface features 110 can be used along any portion of the surface 120 to beneficially enhance fit, comfort, adjustability, etc.

In various additional embodiments, the ability to select and/or change covers 90 provides aesthetic and/or design benefits. For example, a user may wish to express a style preference, show loyalty to a sporting team or alma mater, or coordinate with other aspects of personal style with one or more distinct covers 90. Further, a user may wish to customize a cover 90 (e.g., in terms of color, design, size, etc.) for the purposes of expressing personal style.

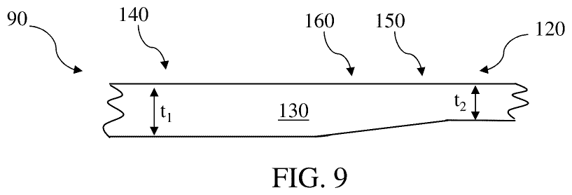

In further implementations, distinct covers 90 can provide distinct clamping forces on the ear of the user. For example, distinct clamping forces can be achieved with distinct durometers, distinct thicknesses, and/or surface features 110. In particular examples, the durometer of a wall 130 of cover 90 can be distinct from the durometer of a wall 130 of cover 90A and/or 90B. In further implementations, walls 130 of cover 90B can be thicker than walls 130 of cover 90A and/or cover 90. Distinctions in durometer and/or thickness can also be combined with surface features 110 to provide distinct clamping forces between covers 90. In a particular example, as illustrated in FIG. 9, the cover 90 has a non-uniform thickness across one or more sections of wall 130. For example, the cover 90 can have a first thickness (t₁) at a first section 140 of the wall 130 and a second, lesser thickness (t₂) at a second section 150 of the wall 130. In some cases, the wall 130 includes a taper on one or more sides to achieve a gradual distinction in thickness. In other cases, the distinction in thickness can be step-wise. In various implementations, the non-uniform thickness provides a progressive or regressive fit adjustment between at least two positions (e.g., between first section 140 and second section 150, and in some cases, an intermediate, or third, section 160). It is understood that in some cases the non-uniform thickness can provide at least two distinct fits. The distinct fits may aid in distinct usage scenarios, e.g., for a relatively sedentary or mild activity state such as sitting or walking, and a relatively active state such as running, biking, exercising, etc.

In still further implementations, the cover 90 is configured for placement in a plurality of positions to adjust a clamping force on the ear of the user. For example, a cover 90 can be configured to rotate relative to the second portion 40 to achieve a plurality of positions. In certain cases, the cover 90 includes a gap 160 aligned with an axis (A_{fp}) of the first portion 30 of the body 20 (FIG. 2). The gap 160 can enable rotation of the cover 90 relative to the second portion 40 of the body, e.g., about the primary axis (A_{pbb}) of the second portion 40.

In some cases, in addition to, or alternatively to surface features 110, one or more implementations of a cover 90 can include internal detents 170 for enabling fit adjustment relative to the user's ear. Detents 170 are shown optionally in phantom in FIGS. 6 and 7, for example. In particular example implementations, detent 170 can include a gripping member, protrusion, recess, etc. that is configured to maintain adjustment of a position of the cover 90 relative to the first portion 30 and/or second portion 40. In some cases (not shown), the outer surface 100 of the first portion 30 and/or second portion 40 can include one or more complementary detents or surface features that are configured to interface with detents 170 in the cover 90 (e.g., along an inner surface 180 of cover 90).

In further implementations, the cover 90 has a directional distinction in grip force characterized by a greater grip force in a direction along the primary axis (A_{pbb}) of the second portion 40 (FIG. 4) than in a direction perpendicular to the primary axis (A_{pbb}) of the second portion 40. In certain cases, the directional distinction in grip force enables rotation of the cover 90 relative to the second portion 40. In still further implementations, the cover 90 includes a reinforcing ring 190 (FIGS. 2, 4, 5) aligned in a plane (P) perpendicular to the primary axis (A) of the second portion (FIG. 4). The reinforcing ring 190 can provide additional structural support for the cover 90 and/or aid in retaining the sidewalls 200 of the cover 90 in place over the ends 210 of the second portion 40.

In particular examples, adjusting the cover 90 provides a majority of an adjustment in clamping force of the open-ear headphone 10. That is, the cover 90 can significantly impact adjustment of clamping force of the open-ear headphone 10 in some cases.

As noted herein, the headphones 10 including cover 90 can provide various benefits relative to conventional open-ear headphones. For example, relative to conventional headphones the disclosed open-ear headphones 10 having an ear cuff and a cover enable enhanced comfort, retention, aesthetic design, and/or acoustic performance. In some examples, the use of a cover with an ear cuff allows for a more secure fit across multiple use scenarios. The improved fit can enable longer, more comfortable usage of the headphones 10, and in some cases, can aid in aligning the acoustic output with the user's ear canal opening to improve acoustic performance. Further, the cover(s) can allow a user to tailor the fit, comfort, acoustic performance and/or aesthetic design of the headphone based on personal preference, activity/usage, etc. Further, because ear sizes and shapes vary significantly between users, the cover(s) can allow for enhanced fit, comfort, acoustic performance across a population of users when compared with conventional open-ear headphones.

In various disclosed examples herein, the headphones 10 can be configured for use as on-ear audio devices, i.e., providing a non-occluding fit. The systems and methods disclosed herein may include or operate in, in some examples, headsets, headphones, hearing aids, or other personal audio devices, as well as acoustic noise reduction systems that may be applied additional audio systems. Throughout this disclosure the terms “headset,” “headphone,” “earphone,” and “headphone set” are used interchangeably, and no distinction is meant to be made by the use of one term over another unless the context clearly indicates otherwise. Additionally, aspects and examples in accord with those disclosed herein are applicable to various form factors, such as in-ear transducers or earbuds and on-ear or over-ear headphones, and others.

Examples disclosed may be combined with other examples in any manner consistent with at least one of the principles disclosed herein, and references to “an example,” “some examples,” “an alternate example,” “various examples,” “one example” or the like are not necessarily mutually exclusive and are intended to indicate that a particular feature, structure, or characteristic described may be included in at least one example. The appearances of such terms herein are not necessarily all referring to the same example.

It is to be appreciated that examples of the methods and apparatuses discussed herein are not limited in application to the details of construction and the arrangement of components set forth in the following description or illustrated in the accompanying drawings. The methods and apparatuses are capable of implementation in other examples and of being practiced or of being carried out in various ways. Examples of specific implementations are provided herein for illustrative purposes only and are not intended to be limiting. Also, the phraseology and terminology used herein is for the purpose of description and should not be regarded as limiting. The use herein of “including,” “comprising,” “having,” “containing,” “involving,” and variations thereof is meant to encompass the items listed thereafter and equivalents thereof as well as additional items. References to “or” may be construed as inclusive so that any terms described using “or” may indicate any of a single, more than one, and all of the described terms. Any references to front and back, left and right, top and bottom, upper and lower, and vertical and horizontal are intended for convenience of description, not to limit the present systems and methods or their components to any one positional or spatial orientation.

For various components described herein, a designation of “a” or “b” in the reference numeral may be used to indicate “right” or “left” versions of one or more components. When no such designation is included, the description is without regard to the right or left and is equally applicable to either of the right or left, which is generally the case for the various examples described herein. Additionally, aspects and examples described herein are equally applicable to monaural or single-sided personal acoustic devices and do not necessarily require both of a right and left side.

Examples of the headphones described herein are not limited in application to the details of construction and the arrangement of components set forth in the following description or illustrated in the accompanying drawings. The headphones are capable of implementation in other examples and of being practiced or of being carried out in various ways. Examples of specific implementations are provided herein for illustrative purposes only and are not intended to be limiting. In particular, functions, components, elements, and features discussed in connection with any one or more examples are not intended to be excluded from a similar role in any other examples.

The term “approximately” as used with respect to values herein can allot for a nominal variation from absolute values, e.g., of several percent or less. Where the term “comprising” is used in the present description and claims, it does not exclude other elements or operations. The term “based on” (as in “A is based on B”) is used to indicate any of its ordinary meanings, including the cases (i) “based on at least” (e.g., “A is based on at least B”) and, if appropriate in the particular context, (ii) “equal to” (e.g., “A is equal to B”). Similarly, the term “in response to” is used to indicate any of its ordinary meanings, including “in response to at least.”

Unless indicated otherwise, any disclosure of an operation of an apparatus having a particular feature is also expressly intended to disclose a method having an analogous feature (and vice versa), and any disclosure of an operation of an apparatus according to a particular configuration is also expressly intended to disclose a method according to an analogous configuration (and vice versa). The term “configuration” may be used in reference to a method, apparatus, and/or system as indicated by its particular context. The terms “method,” “process,” “procedure,” and “technique” are used generically and interchangeably unless otherwise indicated by the particular context. The terms “apparatus” and “device” are also used generically and interchangeably unless otherwise indicated by the particular context. The terms “element” and “module” are typically used to indicate a portion of a greater configuration. Any incorporation by reference of a portion of a document shall also be understood to incorporate definitions of terms or variables that are referenced within the portion, where such definitions appear elsewhere in the document, as well as any figures referenced in the incorporated portion.

Other embodiments not specifically described herein are also within the scope of the following claims. Elements of different implementations described herein may be combined to form other embodiments not specifically set forth above. Elements may be left out of the structures described herein without adversely affecting their operation. Furthermore, various separate elements may be combined into one or more individual elements to perform the functions described herein.

Having described above several aspects of at least one example, it is to be appreciated various alterations, modifications, and improvements will readily occur to those skilled in the art. Such alterations, modifications, and improvements are intended to be part of this disclosure and are intended to be within the scope of the invention. Accordingly, the foregoing description and drawings are by way of example only, and the scope of the invention should be determined from proper construction of the appended claims, and their equivalents.

We claim:

1. An open-ear headphone, comprising:
an acoustic module configured to be located at least in part in a cavum conchae of an outer ear of a user, the acoustic module having an acoustic transducer and a first sound-emitting opening;
a body coupled to the acoustic module, the body having:
a first portion configured to pass over an outer side of at least one of an anti-helix, a helix, or a lobule of the outer ear, and
a second portion configured to be located behind the outer ear; and
a cover over the body for controlling a fit of the open-ear headphone on the ear.

2. The open-ear headphone of claim 1, wherein the cover is removable.

3. The open-ear headphone of claim 1, wherein the body is sized to receive a plurality of distinct covers for providing distinct fits of the open-ear headphone on the ear of the user.

4. The open-ear headphone of claim 3, wherein distinct covers provide distinct clamping forces on the ear of the user.

5. The open-ear headphone of claim 3, wherein the distinct covers have distinct durometers.

6. The open-ear headphone of claim 1, wherein the cover is configured for placement in a plurality of positions to adjust a clamping force on the ear of the user.

7. The open-ear headphone of claim 6, wherein the cover is rotatable relative to the second portion to achieve the plurality of positions.

8. The open-ear headphone of claim 7, wherein the cover includes a gap aligned with an axis of the first portion of the body, the gap enabling rotation of the cover relative to the second portion of the body.

9. The open-ear headphone of claim 7, wherein the cover has a non-uniform thickness such that interaction between a first portion of the cover and the user's ear provides a distinct fit from interaction between a second portion of the cover and the user's ear, wherein the non-uniform thickness provides a progressive or regressive fit adjustment between at least two positions.

10. The open-ear headphone of claim 1, wherein the cover includes:
a) at least one surface feature for enhancing grip on the ear of the user, and/or
b) at least one compliant surface feature for enhancing fit on the ear of the user.

11. The open-ear headphone of claim 1, wherein adjusting the cover provides a majority of an adjustment in clamping force of the open-ear headphone.

12. The open-ear headphone of claim 1, wherein the cover has a directional distinction in grip force characterized by a greater grip force in a direction along a primary axis of the second portion than in a direction perpendicular to the primary axis of the second portion.

13. The open-ear headphone of claim 12, wherein the directional distinction in grip force enables rotation of the cover relative to the second portion.

14. The open-ear headphone of claim 12, wherein the cover includes a reinforcing ring aligned in a plane perpendicular to the primary axis of the second portion.

15. The open-ear headphone of claim 1, wherein the cover includes a plurality of internal detents for enabling fit adjustment relative to the user's ear.

16. The open-ear headphone of claim 1, wherein the second portion includes a battery housing that houses a battery, wherein an outer surface of the battery housing includes a non-compliant material.

17. The open-ear headphone of claim 1, wherein the first sound-emitting opening is configured to be spaced from and proximate the user's ear canal opening.

18. The open-ear headphone of claim 1, wherein at least one of the anti-helix, the helix, or the lobule of the outer ear is configured to be located between the first portion and the second portion of the body.

19. The open-ear headphone of claim 1, wherein the body is generally L-shaped, and wherein the acoustic module and the body together are generally C-shaped.

20. The open-ear headphone of claim 1, further comprising at least one microphone located in the acoustic module and/or the body.
